(19) United States
(12) Patent Application Publication
(10) Pub. No.: US 2011/0315451 A1
(43) Pub. Date: Dec. 29, 2011

(54) DRIVE SYSTEM FOR A DOWNHOLE TOOL

(76) Inventors: Edward Docherty Scott, Cardenden (GB); Neil Andrew Abercrombie Simpson, Aberdeen (GB)

(21) Appl. No.: 13/169,166

(22) Filed: Jun. 27, 2011

(30) Foreign Application Priority Data
Jun. 25, 2010 (GB) 1010702.7

(51) Int. Cl. E21B 4/02; F03B 13/02; E21B 4/00

(52) U.S. Cl. 175/107; 173/218; 173/1

(57) ABSTRACT

A turbine drive system (10) for a downhole tool comprises a stator (12) and a rotor (14). The rotor (14) is mounted externally of the stator (12) and, in use, the rotor (14) is rotated relative to the stator (12) to drive the downhole tool. The stator (12) is provided with a through bore (15) for providing access through the drive system (10).

### CROSS-REFERENCE TO RELATED APPLICATIONS

Priority is claimed from British Patent Application No. GB 1010702.7 filed on Jun. 25, 2010.

### STATEMENT REGARDING FEDERALLY SPONSORED RESEARCH OR DEVELOPMENT

Not Applicable

### BACKGROUND TO THE INVENTION

1. Field of the Invention

This invention relates to a drive system for a downhole tool. In particular, but not exclusively, embodiments of the invention relate to a drive system for use in a variety of downhole applications in the oil and gas and/or mining industries.

2. Related Art

In order to perform operations in a borehole, such as a wellbore or mineshaft, a variety of tools may be attached to and run into the bore on a tubular or string of connected tubulars, known as a running string. In some instances, the tools may be run into the bore on bore-lining tubulars, such as casing or liner. In other instances, the tool may be run into the bore on drill pipe, such as may be used during drilling of the bore.

One example of an operation that may be carried out in a borehole is coring, whereby a core sample of earth or rock is obtained and retrieved for analysis purposes. This involves deploying an annular cutter called a coring head on the end of the running string, the coring head being operable to remove an annular volume of material to create a core which may then be captured and retrieved to surface.

In the oil and gas industry, coring is normally carried out in relatively soft sedimentary rock formations and cores may be obtained using a polycrystalline diamond compact (PDC) or surface set synthetic diamond material core head driven, for example, by a positive displacement motor (PDM) operable at around 100 to 400 rpm.

However, the continuing search for hydrocarbons means that coring operations may encounter, or may be required to be carried out in, much harder materials such as volcanic tuff, dolomite and very hard well-cemented quartzitic sandstones.

Similarly, in the mining industry much of the rock encountered is igneous (non sedimentary) in nature and it is common for long sections of the bore to be cored. This is especially the case when mining caverns for the disposal and storage of nuclear waste where the rock type being cored is generally granitic in nature.

Coring in hard materials may be achieved using impregnated diamond core heads. However, in order to be effective these must be operated with minimal vibration and at high rotational speeds, typically in the region of 600 rpm and in some cases more than 1000 rpm, which are not achievable using conventional PDM drive systems.

### SUMMARY OF THE INVENTION

According to a first aspect of the invention there is provided a turbine drive system for a downhole tool, the drive system comprising a stator and a rotor, wherein the rotor is provided externally of the stator and is adapted for rotation relative to the stator to drive a downhole tool, and wherein the stator comprises a through bore for providing tool access through the drive system.

In use, the provision of a turbine drive system according to embodiments of the present invention facilitates low vibration, high speed operation of a range of downhole tools and assemblies, including for example but not exclusively tubing or drill pipe deployed coring, drilling, cutting, reaming, milling or grinding devices such as drillable casing shoes, milling tools. Embodiments of the invention are also capable of supporting substantial compressive and tensile loads across the rotor and stator and can support substantial pressure differentials between the through bore of the stator and the outside diameter of the rotor.

In particular embodiments, the turbine drive system may facilitate low vibration, high rotational speed coring operations to be carried out through hard materials using impregnated diamond core heads at speeds not otherwise possible using conventional PDM drive systems.

In alternative embodiments, the turbine drive system may be used to power a pump, downhole tractor, or other conveyance device for assisting in moving or controlling the position of the tubular string in the bore.

In addition, the provision of an internal stator having a through bore permits access through the drive, for example for the recovery of cores and/or the passage of other tubular or tubular deployed assemblies through the drive system where it is desired to access sections of the borehole below a deployed tool.

The through bore may be of any suitable configuration, size or shape. In particular embodiments, the through bore may be of sufficient size to permit substantially full bore access through the drive system, that is the through bore does not restrict the bore through the tubular string. A full bore, or substantially full bore, will allow normal access of additional subsequent tubulars to pass through the full bore for production and or drilling purposes, without any significant reduction in size such that production or drilling operations can take place unimpeded by the presence of the full bore turbine system.

In particular embodiments, the drive system may be configured for location at an intermediate position in the tubular string. For example, the drive system may be configured so as to be coupled between two sections of a tubular string.

In other embodiments, the drive system may be configured for location adjacent a distal leading end of a tubular string. For example, the drive system may be configured for coupling between the end of the tubular string and a bottom hole assembly, including for example a coring head, reaming tool, or other device.

The ability to position the drive system at a distal location and/or at an intermediate location in the tubular string means that the drive system may be used to power a variety of tools, and tool operations.

The drive system may comprise a connection arrangement for coupling the drive system to the tubular string. The connection arrangement may be of any suitable form, including for example a threaded connection, box and pin connection, quick connect or other suitable connector.

The connection arrangement may be provided on, or formed on, the stator of the drive system. Alternatively, the connector arrangement may be provided on, or formed on, a separate component adapted for coupling to the stator.

The stator may comprise a stator shaft. At least one static turbine component may be adapted for coupling to, or may be formed on, the stator. The at least one static turbine component may comprise one or more of a turbine stator blade, a bearing, a seal, and associated retention systems.

In another configuration, connections at the top and bottom of the stator with the outer turbine being free to rotate between those connections would allow one or more sleeve mounted reaming, cleaning or conditioning device to be powered in a string of tubulars by the drive system.

The rotor may comprise a rotatable turbine rotor housing configured for mounting around the stator. At least one rotoric turbine component may be adapted for coupling to, or may be formed on, the rotor. The at least one rotoric turbine component may comprise one or more of; a turbine rotor blade, a bearing, a seal, a flow control device, and associated retention systems.

In some embodiments, the rotor may be configured to be coupled at least partly around the stator. Alternatively, the rotor may be configured for coupling to an end of the stator.

The rotor may further comprise a connection arrangement for coupling to the stator. The rotor may further comprise a connection arrangement for coupling to the downhole tool. The rotor connection arrangement or arrangements may be of any suitable form, including for example a threaded connection, box and pin connection, quick connect or other suitable connector. The rotor connection arrangement or arrangements may be provided on, or formed on, the rotor of the drive system. Alternatively, the connection arrangement(s) may be provided on, or formed on, a separate component adapted for coupling to the rotor.

The rotor turbine blade(s) and stator turbine blade(s) may together form a drive system turbine section. The drive system may define a fluid passage adapted to receive fluid to drive the turbine section and thereby the rotor relative to the stator.

In use, the fluid passing through the internal bore of the turbine stator, or through an annular space between a tubular assembly run through the internal bore of the turbine stator, may be diverted into the drive system turbine section to provide rotational power to drive the turbine rotor, and in turn the attached downhole tool.

Substantially all, or at least the bulk of, the fluid exiting from the turbine section may be diverted back into the internal bore of the turbine stator shaft or into the annular space between a tubular assembly run through the internal bore of the turbine stator shaft, although a small amount of this exiting fluid may be diverted through a bearing section for lubrication and cooling and then returned to the turbine stator bore or annular space downstream of the drive system.

The drive system may further an inlet port and an outlet port, the ports configured to direct the fluid into and out from the drive system turbine section. The drive system may further comprise a flow restriction in order to urge the fluid through the turbine section.

The drive system may be modular in construction. Alternatively, the drive system may be integral to the downhole tool which it is desired to operate using the drive system.

According to another aspect of the invention, there is provided an assembly comprising:

a tubular; and

a drive system according to the first aspect of the invention, the drive system adapted to be coupled to the tubular; and

a downhole tool adapted to be run into a borehole on the tubular and which is adapted to be rotated with respect to the tubular by the drive system.

The assembly may comprise a single drive system. Alternatively, the assembly may comprise a plurality of the drive systems. For example, one drive system may be provided adjacent a distal leading end of a tubular string to drive rotation of a tool located at the distal leading end of the string, such as a coring head, and one or more other drive system may be provided at an intermediate location on the tubular string to drive a tool located at an intermediate location, such as a reaming tool, cleaning device, downhole tractor and/or other conveyance device for assisting in running in or otherwise positioning the tubular string in the bore.

According to a further aspect of the present invention, there is provided a method of powering a downhole tool, the method comprising:

providing a turbine drive system comprising a stator and a rotor, wherein the rotor is provided externally of the stator, and wherein the stator comprises a through bore for providing tool access through the drive system;

directing fluid through the turbine drive system to rotate the rotor relative to the stator to drive a downhole tool.

It should be understood that the features defined above in accordance with any aspect of the present invention or described below in relation to a specific embodiment of the invention may be utilised, either alone or in combination, with any other defined feature, in any other aspect of the invention.

### BRIEF DESCRIPTION OF THE DRAWINGS

These and other aspects of the present invention will now be described, by way of example only, with reference to the accompanying drawings, in which:

FIG. 1 shows a cross sectional view of a turbine drive system according to an embodiment of the invention, shown coupled to a coring tool; and

FIG. 2 shows an enlarged view of part of FIG. 1, showing the turbine drive system.

### DETAILED DESCRIPTION

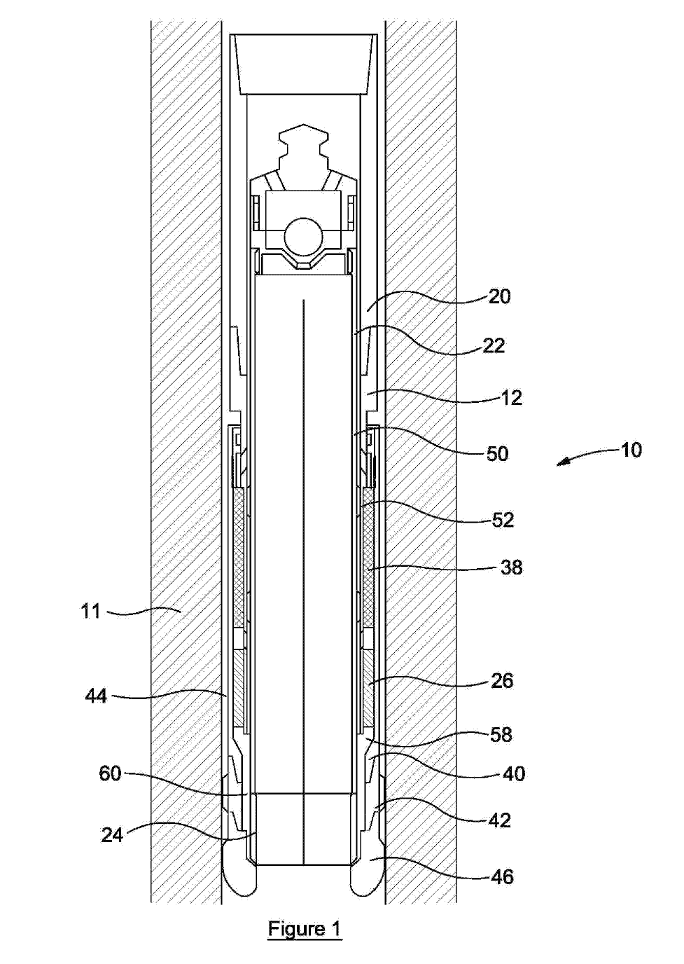

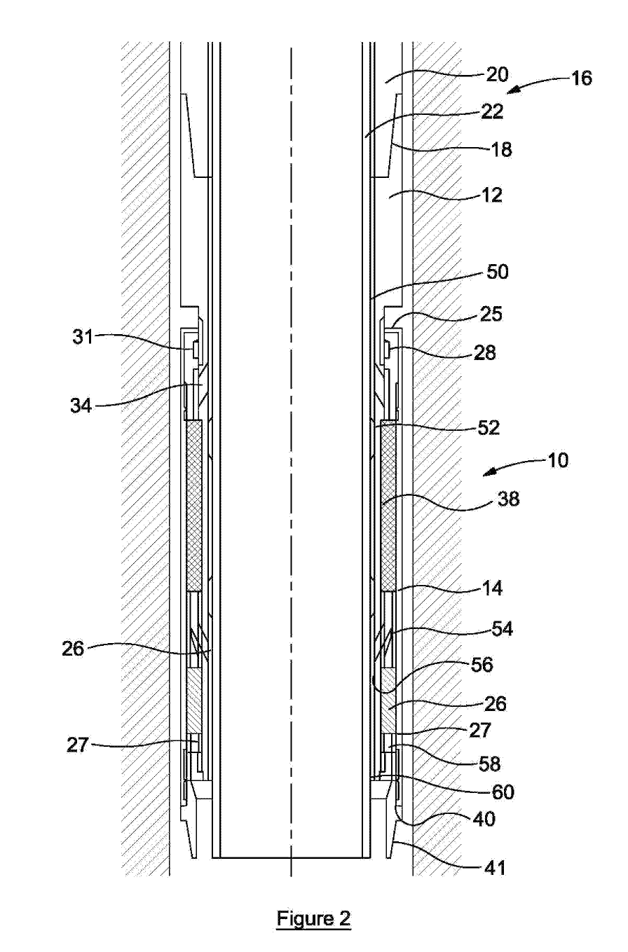

FIGS. 1 and 2 show a cross sectional view and an enlarged cross sectional view respectively of a turbine drive system 10 comprising a stator 12 and an externally mounted rotor 14 according to an embodiment of the present invention. The stator 12 is provided with a large through bore 15.

In use, the drive system 10 is adapted for location in a wellbore 11, the drive system rotor 14 adapted for rotation relative to the stator 12 to provide low vibration, high speed rotation of a connected downhole tool to perform an operation in the wellbore 11. The through bore 15 is configured to permit substantially full bore access through the drive system 10 and permit, for example, passage of a tool (not shown) through the drive system 10.

In the embodiment shown in the figures, the drive system 10 is coupled to a coring tool 16 although it will be recognised that the drive system 10 may alternatively be configured to interface with and provide high speed rotational power to drive a wide range of downhole tubing or drill pipe deployed assemblies and/or devices, located either at a distal leading end of tubular string or at an intermediate location along a tubular string.

Referring first to FIG. 1, an upper end of the stator 12 of the drive system 10 defines a threaded box connector 18 and the stator 12 is threadably attached at its upper end to a conventional core barrel outer tube 20 of the coring tool 16. A core barrel inner tube 22 is provided within the outer tube 20, the inner tube 22 passing through the outer tube 20 and also through the stator 12 and rotor 14 of the drive system 10 and terminating at its lower end in a core catcher shoe 24.

The rotor 14 of the drive system 10 is rotationally mounted externally of the stator 12 via plain bearing 25, bearing stack 26 and bearing retainers 27, in use, the compressive and tensile loads applied to the drive system 10 are supported by the bearing stack 26.

The rotating interface between the stator 12 and the rotor 14 is sealed by a rotation fluid seal 28 provided in a recess 30 in the rotor 14 and held in place by seal retainer ring 31.

A fluid passage 32 is defined between the outside of the stator 12 and the inside of the rotor 14, the fluid passage 32 accessed via an inlet port 34 and an outlet port 36.

Both the stator 12 and the rotor 14 are provided with a number of turbine blades (not shown) which together form a turbine power section 38 of the drive system 10, the turbine power section 38 arranged to receive fluid directed into the fluid passage to drive rotation of the rotor 14 relative to the stator 12.

In the embodiment shown, the lower end of the rotor 14 is coupled to a crossover sub 40 having threaded pin connector 41. The crossover sub 40 is in turn coupled to a core barrel outer stabiliser sub 42 which may be used to maintain an annulus 44 between the coring tool 16 and the wellbore 11. The stabiliser sub 42 is in turn connected to a core head 46 such that, in use, rotation of the rotor 14 drives rotation of the core head 46 to perform a coring operation in the wellbore 11.

In use, drilling fluid pumped from surface passes through upper annular space 50 provided between the core barrel inner tube 22 and the core barrel outer tube 20. Annular space 50 is blocked by annular pack off ring 52 which is located on the core barrel inner tube 22 as it passes through the large bore of the stator 12. This forces the drilling fluid to enter the top of the turbine power section 38 under pressure via the inlet port 34.

This pressurised flow of drilling fluid passing through the turbine power section 38 generates low vibration, high speed torque from the static and rotoric turbine blades (not shown) within the turbine power section 38 to rotate the rotor 14 with respect to the stator 12.

The power generated in the rotor 14 is transmitted via the crossover sub 40 to the core barrel outer stabiliser sub 42 and from there to the core head 46.

As can be seen most clearly in FIG. 2, fluid exiting the power section 38 is split into two paths with the main flow exiting via the turbine outlet port 36 while a small percentage of the flow is diverted through a leakage control restriction 54 to lubricate and cool the bearing stack 26.

From there, the flow passes back into a lower annular space 56 via the bearing leakage outlet 58 at the entry point 60. From there, the flow passes into the core barrel stabiliser sub 42 between the core catcher shoe 24 and the throat of the core head 46 to provide cooling and cleaning before returning to surface via the annulus 44 between the core barrel outer tube 20 and the wellbore 11.

It should be understood that the embodiment described herein is merely exemplary and that various modifications may be made thereto without departing from the scope of the invention.

For example, the above example shows how the large bore fluid driven axial flow turbine module can be integrated into a conventional core barrel assembly. However this large bore fluid driven axial flow turbine module can be similarly used in a variety of other applications that require a large internal bore modular power section, such as wash over shoes, hole reaming or casing cleaning assemblies, packer pickers and other similar devices used down hole.

Although both the stator and rotor are described above as comprising turbine blades, it will be understood that only one of the stator and rotor may alternatively comprise a turbine blade or blades.

Although the fluid inlet is shown above the turbine power section, the fluid inlet may alternatively be provided at an intermediate entry point to the turbine section so that flow may be directed in alternate directions through the power section. Such an arrangement provides the additional benefit of balancing axial forces across the power section which may otherwise damage or reduce the operational lifetime of the system bearings.

1. A turbine drive system for a downhole tool, the drive system comprising a stator and a rotor, wherein the rotor is provided externally of the stator and is adapted for rotation relative to the stator to drive a downhole tool, and wherein the stator comprises a through bore for providing access through the drive system.

2. The drive system of claim 1, wherein the downhole tool comprises at least one of: a coring tool; a drilling tool; a cutting tool; a reaming tool; a milling tool; a grinding tool; a casing shoe; a pump; and a downhole tractor.

3. The drive system of claim 1, wherein the through bore permits substantially full bore access through the drive system.

4. The drive system of claim 1, wherein the drive system is configured for location at an intermediate position in the tubular string.

5. The drive system of claim 1, wherein the drive system is configured for location adjacent a distal leading end of a tubular string.

6. The drive system of claim 1, further comprising a connection arrangement for coupling the drive system to a tubular string.

7. The drive system of claim 6, wherein the connection arrangement comprises at least one of: a threaded connection; a box and pin connection; and a quick connect device.

8. The drive system of claim 6, wherein the connection arrangement is provided on, or formed on, the stator of the drive system.

9. The drive system of claim 1, wherein the rotor further comprises a connection arrangement for coupling to the downhole tool.

10. The drive system of claim 9, wherein the rotor connection arrangement comprises at least one of: a threaded connection; a box and pin connection; and a quick connect device.

11. The drive system of claim 1, wherein at least one turbine component is adapted for coupling to, or is formed on, the stator.

12. The drive system of claim 1, wherein at least one turbine component is adapted for coupling to, or is formed on, the rotor.

13. The drive system of claim 1, further comprising a drive system turbine section.

14. The drive system of claim 13, wherein the drive system defines a fluid passage adapted to receive fluid to drive the turbine section and thereby the rotor relative to the stator.

15. The drive system of claim 1, wherein the drive system is modular in construction.

16. The drive system of claim 1, wherein the drive system is integral to the downhole tool.

17. An assembly comprising:
a tubular; and
a drive system according to the first aspect of the invention, the drive system adapted to be coupled to the tubular; and
a downhole tool adapted to be run into a borehole on the tubular and which is adapted to be rotated with respect to the tubular by the drive system.

18. The assembly of claim 17, comprising a single drive system.

19. The assembly of claim 17, comprising a plurality of the drive systems.

20. A method of powering a downhole tool, the method comprising:
providing a turbine drive system comprising a stator and a rotor, wherein the rotor is provided externally of the stator, and wherein the stator comprises a through bore for providing tool access through the drive system;
directing fluid through the turbine drive system to rotate the rotor relative to the stator to drive a downhole tool.
